(19) United States
(12) Patent Application Publication
(10) Pub. No.: US 2008/0186131 A1
(43) Pub. Date: Aug. 7, 2008

(54) Certification system and method

(75) Inventors: Hiromichi Hanai, Kariya-city (JP); Haruyuki Ikeo, Chiryu-city (JP); Munenori Matsumoto, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/010,647

(22) Filed: Jan. 28, 2008

(30) Foreign Application Priority Data
Feb. 2, 2007 (JP) 2007-24342

(51) Int. Cl. G05B 19/00

(52) U.S. Cl. 340/5.2

(57) ABSTRACT

In a certification system, a smart security controller transmits to a portable terminal a designation request signal for which a response frequency is designated. In a case where any signal cannot be received within a preset allowable time period after the transmission of the designation request signal, the smart security controller transmits a designation request signal whose response frequency has been altered to a different frequency. The portable terminal selects the response frequency designated by the designation request signal, and transmits a reception response signal to the smart security controller at the selected response frequency. Accordingly, the response signal can be prevented from becoming unreceivable on account of the radio interference of the response signal.

### CROSS REFERENCE TO RELATED APPLICATION

This application is based on and incorporates herein by reference Japanese Patent Application No. 2007-24342 filed on Feb. 2, 2007.

### FIELD OF THE INVENTION

The present invention relates to a certification system and method, in which a controller and a certification medium carried by a user of the controller perform a certification by radio communications.

### BACKGROUND OF THE INVENTION

In a conventional certification system, when a predetermined manipulation portion disposed in a vehicle is manipulated by an authorized user carrying a certification medium such as an IC card, the certification medium and a controller mounted in the vehicle perform certification processing by radio communications (US 2006/0017550 corresponding to JP 2006-037396A).

The certification system is so configured that, when the certification between the controller and the certification medium is successful, doors of the vehicle as an object to be controlled is locked or unlocked.

However, the certification between the controller and the certification medium does not normally proceed, when it undergoes the influence of a factor hampering the radio communications, such as jamming electric waves. As a result, in spite of the manipulation of the manipulation portion by the authorized user, the object to be controlled sometimes fails to operate.

### SUMMARY OF THE INVENTION

The present invention therefore has an object to provide a certification system and method, wherein a controller and a certification medium carried by a user of the controller perform a certification by radio communications, in which the radio communications are made less susceptible to jamming electric waves and the like factor hampering these radio communications, whereby an object to be controlled can be normally actuated.

In a certification system and method, a certification medium is carried by a user and a controller is mounted in a moving object to perform a certification of the medium by radio communications. The controller transmits a designation request signal to the certification medium when a manipulation unit of the controller is manipulated. The designation request signal designates a response frequency. The designation request transmission signal is transmitted again by altering the response frequency to a different frequency, in a case where no signal responsive to the designation request signal is received from the certification medium within a preset allowable time period after the transmission of the designation request signal. The controller checks whether an identifier contained in a certification response signal and an identifier possessed by the controller agree, when the certification response signal containing the identifier for specifying the certification medium is received from the certification medium. The certification medium selects a response frequency designated by the designation request signal from among a plurality of frequencies, when the designation request signal is received. The certification medium transmits the certification response signal containing the identifier for specifying the certification medium to the controller at the selected response frequency, after the selection of the response frequency.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a certification system implemented in a vehicular electronic key system according to an embodiment of the present invention;

FIG. 2 is flow chart showing a smart entry control process executed by a smart security controller in the embodiment;

FIG. 3 is a flow chart showing a response process executed in a portable terminal in the embodiment; and

FIG. 4 is a timing chart showing exchanges of signals between the portable terminal and the smart security controller.

### DESCRIPTION OF THE PREFERRED EMBODIMENT

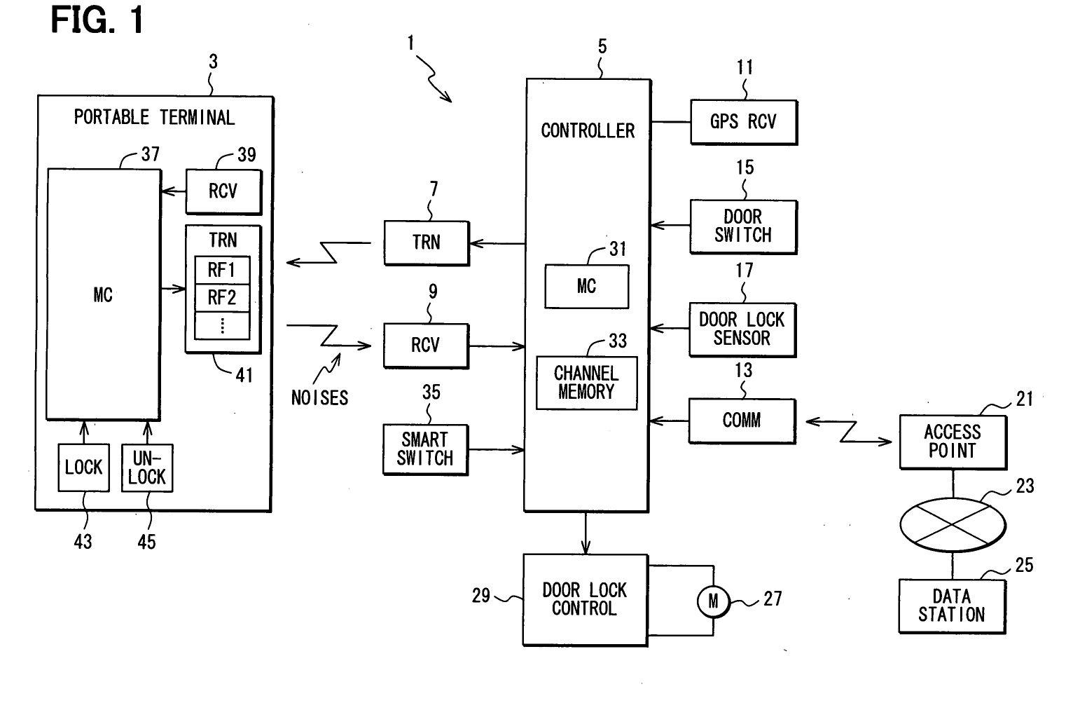

Referring first to FIG. 1, a vehicular electronic key system 1 embodying a certification system includes a portable terminal (certification medium) 3 which is carried by a user of a vehicle (moving object), and a smart security controller 5 which is an in-vehicle controller mounted in the vehicle.

To the smart security controller 5, there are connected a GPS receiver (present location detection unit) which receives electric waves from well-known GPS satellites, thereby to detect the present location of the particular vehicle, and a communication unit 13 (communication unit) which transmits and receives electric waves through an antenna not shown, thereby to perform two-way radio communications with an access point 21, for example, a portable telephone.

The access point 21 is connected to a data station 25 (data record unit) through the Internet 23. The smart security controller 5 is so configured as to be capable of executing a process for reading out channel information (to be detailed later) recorded in the data station 25, through the communication unit 13, the access point 21 and the Internet 23, and a process for supplementing channel information into the data station 25 through them.

To the smart security controller 5, there are connected a transmitter (on-vehicle transmitter) 7, which transmits a transmission request signal to a predetermined sensing area outside the vehicle, a receiver (on-vehicle receiver) 9 which receives a signal transmitted from the portable terminal 3 by radio, a door opening detection switch 15 which detects the open or closed state of a door, a door lock sensor 17 which detects the locked or unlocked state of the door, a door lock controller 29 (object to be controlled) which drives and controls a door lock motor 27 for locking or unlocking the door of the vehicle, and a smart switch 35 (actuation unit) with which the user inputs a command for locking or unlocking the door.

Here, the transmitter 7 transmits predetermined data in such a way that an electric wave whose carrier wave is an electric wave of LF (low frequency) band (for example, an electric wave in the vicinity of 134 MHz) is subjected to the modulation of FM or AM.

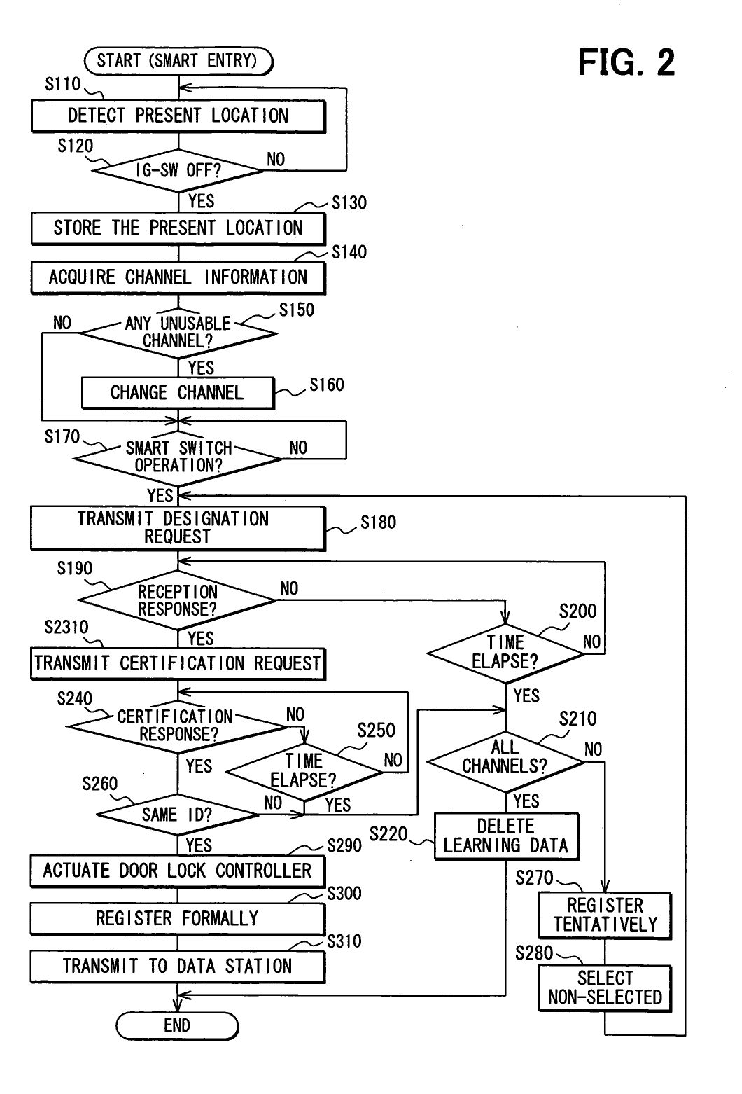

Besides, the receiver 9 is so configured as to receive an electric wave of UHF (ultra high frequency) band in a preset range. Further, the receiver 9 has a tuning function for sensitively receiving with an electric wave of predetermined frequency aimed at. More specifically, in a case where a response signal is outputted to the portable terminal 3 at a designated response frequency in a smart entry control process (FIG. 2) to be explained later, the receiver 9 tunes its reception frequency to the response frequency transmitted from the portable terminal 3 and then receives the response signal.

The “response frequency” shall signify the frequency of an electric wave transmitted from the portable terminal 3, and the “transmission frequency” shall signify the frequency of an electric wave transmitted from the smart security controller 5.

Next, the smart security controller 5 includes a microcomputer 31 governing the operation of this controller 5, and a channel information record unit (memory) 33, in addition to the above configuration.

Here, a large number of channel information items (frequency data) with each of which the present location of the vehicle, a usable (available) channel and an unusable (unavailable) channel are associated are recorded in the channel information record unit 33. The channel information recorded in the channel information record unit 33 has been acquired from the data station 25, or it has been detected by the electronic key system 1.

In the electronic key system 1, the door opening detection switch 15, door lock sensor 17, door lock motor 27 and smart switch 35 are disposed for each of the doors of the vehicle. Besides, in this embodiment, the sensing area in which the transmitter 7 transmits the transmission request signal is, for example, a range of fixed distance (for example, 70 cm) from a door handle which is disposed outside the door of the driver's seat of the vehicle.

The portable terminal 3 includes a microcomputer 37 which governs the functions of this portable terminal 3, a receiving unit 39 which receives each request signal transmitted at the predetermined transmission frequency from the transmitter 7, by a receiving antenna (not shown), and which inputs data contained in the request signal, to the microcomputer 37. The portable terminal 3 also includes a transmitting unit 41 which transmits a radio signal containing data and outputted from the microcomputer 37, from a transmitting antenna (not shown). Besides, the portable terminal 3 includes a locking button 43 which is pressed when the door of the vehicle is to be locked, and an unlocking button 45 which is pressed when the door of the vehicle is to be unlocked.

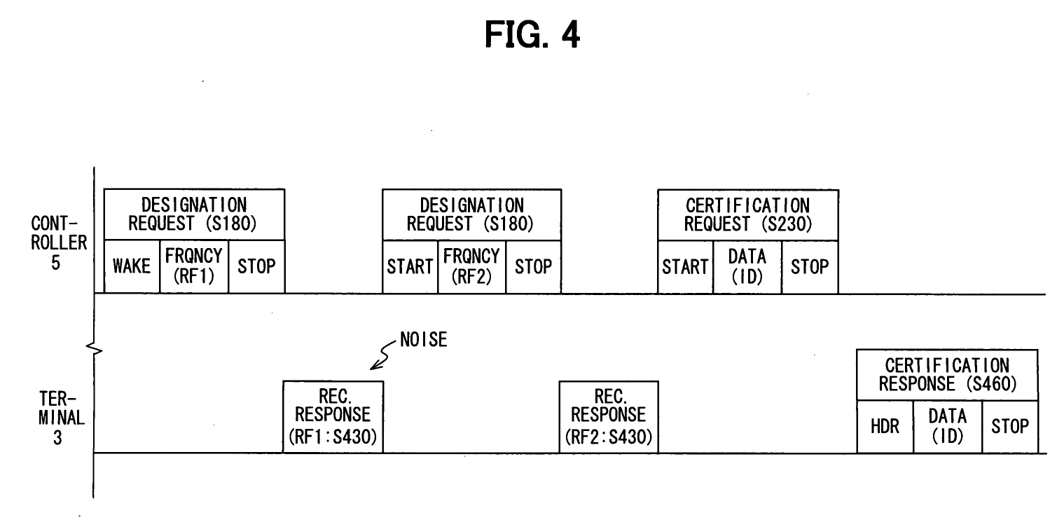

In a response process to be explained later (FIG. 4), the transmitting unit 41 transmits predetermined data in such a way that the response frequency designated from among a plurality of response frequencies is selected, and that the electric wave whose carrier wave is at the selected response frequency is subjected to the modulation of FM or AM. The portable terminal 3 is so configured as to return a reception response signal at the designated frequency to the received designation request signal, and a certification response signal to a certification request signal, by employing the transmitting unit 41.

An electric wave within the range of, for example, a 300-400 MHz band in the UHF band is set for the response frequency selectable by the transmitting unit 41, and a plurality of channels (RF1, RF2, . . . ) are set within the range. Therefore, the channel of the response frequency is designated in the smart security controller 5, while the response signal is transmitted by the designated channel in the portable terminal 3.

Besides, an ID (identifier) for specifying each device (each of the smart security controller 5 and the portable terminal 3) is recorded in a ROM (not shown) included in each device. Here, same IDs may be assigned to the respective devices, or different IDs may well be assigned to them. In a case where the different IDs are assigned to the respective devices, each of the devices needs to bear the ID of the opposite device (or data obtained by encrypting the ID), together with the ID of its own. It is assumed in this embodiment that the same IDs are assigned to the respective devices.

In the electronic key system 1 configured as above, the smart security controller 5 performs a smart control (the smart entry control process) which locks/unlocks the door by sensing that the portable terminal 3 dedicated to the particular vehicle exists within the sensing area, a remote keyless entry control which locks/unlocks the door in such a way that the user presses the locking button 43 or unlocking button 45 of the portable terminal 3, and so forth.

Meanwhile, in the electronic key system 1, the electric wave of the UHF band which the portable terminal 3 uses in the transmission is more susceptible to noise (jamming noise) developing from a communication cable, a large-sized display device, etc. and accordingly tends to undergo radio interference (namely, a communication abnormality) more, as compared with the electric wave of the LF band which the smart security controller 5 uses. In this embodiment, therefore, the process to be explained below is executed so that the response signal from the portable terminal 3 may become less susceptible to the jamming noise in the case of the smart control.

The smart entry control process is executed by the microcomputer 31 of the smart security controller 5 as shown in FIG. 2.

The smart entry control process is started, for example, when the ignition switch (IG-SW) of the vehicle, not shown, is turned on. First, the present location of the vehicle is detected on the basis of the detection result of the GPS receiver 11 (S110). In addition, whether or not the ignition switch has been turned off is checked (S120).

Unless the ignition switch is turned off (S120: NO), the control process returns to the step S110. If the ignition switch is turned off (S120: YES), the information of the newest present location is stored in a RAM included in the microcomputer 31 (S130).

In addition, channel information is acquired from the channel information record unit 33 (S140), and the existence or absence of the channel information corresponding to an unusable or unsuccessful channel at the present location of the vehicle is checked (S150). In the processing of S140, the channel information may be acquired from only the channel information record unit 33, or it may well be acquired from the data station 25 through the communication unit 13. Besides, in a case where the channel information has been acquired from the data station 25, the acquired information may well be stored into the channel information record unit 33.

Besides, in the case where the existence or absence of the channel information indicating unusable channel in relation to the present location of the vehicle is checked at the processing of S150, the present location of the vehicle and a present location contained in the channel information need not come into perfect agreement. If the present location of the vehicle lies within a predetermined range within which the jamming noise might highly be influential in the same manner as at the present location of the vehicle, the existence of the channel information indicating the unusable channel corresponding to the present location of the vehicle may be determined. The predetermined range is, for example, within a radius of 200 m from the present location contained in the channel information.

In the existence of the channel information indicating the unusable channel corresponding to the present location of the vehicle (S150: YES), a designated channel is changed by setting a usable channel (CH) as the designated channel on the basis of this channel information (S160). S160 thus specifies a channel frequency. On this occasion, a reception frequency by the receiver 9 is set at a frequency corresponding to the designated channel. In addition, whether or not the smart switch 35 has been actuated is checked (S170).

In a case where the information of the usable channel does not exist at the processing of S160, any channel other than an unusable channel is set as a designated channel. Besides, in the absence of the channel information corresponding to the present location of the vehicle (S150: NO), the control process directly shifts to S170.

Unless the smart switch 35 is manipulated (S170: NO), the processing of S170 is repeated. If the smart switch 35 is manipulated (S170: YES), a designation request signal (to be detailed later) in which the designated predetermined channel (default channel in the case of the shift from S150) is designated as a response frequency is transmitted to the portable terminal 3 (S180).

Subsequently, the microcomputer 31 checks whether or not a reception response signal (to be detailed later) which is a response signal to the designation request signal has been received from the portable terminal 3 within a predetermined time period previously set (S190 and S200). In a case where the reception response signal has not been received (S190: NO), the processing of S190 and S200 is repeated until the elapse of the predetermined time period (S200: NO). In a case where the reception response signal has not been received within the predetermined time period (S190: NO, and S200: YES), the microcomputer 31 checks whether or not the portable terminal 3 has already selected all transmittable channels (S210).

If all the channels have been selected (S210: YES), learning data stored in the RAM (the information of channels learned and tentatively registered) are deleted (S220), and the smart entry control process is ended. If any channel is not selected (S210: NO), the information of a channel through which the signals such as the reception response signal have failed to be normally received is registered in the RAM as an unusable channel (S270: learning tentative registration). Subsequently, the non-selected channel is selected (S280), that is, frequency is altered, whereupon the control process returns to the processing of S180.

In a case where the reception response signal has been received at the processing of S190 (5190: YES), a certification request signal (to be detailed later) is transmitted to the portable terminal 3 (S230). In addition, the microcomputer 31 checks whether or not a certification response signal (to be detailed later) being a response signal to the certification request signal has been received from the portable terminal 3 within a predetermined time period previously set (S240 and S250).

In a case where the certification response signal has not been received (S240: NO), the processing of S240 and S250 is repeated before the lapse of the predetermined time period (S250: NO). In a case where the certification response signal has not been received within the predetermined time period (S240: N0 and S250: YES), the processing of S210, et seq. is executed.

Further, in a case where the certification response signal has been received (S240: YES), the microcomputer 31 checks whether or not the ID contained in the certification response signal and the ID previously recorded in the ROM included in the smart security controller 5 are the same (S260). If the IDs do not agree (S260: NO), the processing of S210, et seq. stated above is executed.

If the IDs agree (S260: YES), the function of the door lock controller 29 is actuated by regarding the certification of the ID as being successful (S290). Here, as the function of the door lock controller 29, it is considered to perform different actuations in accordance with detection states based on the door opening detection switch 15 and the door lock sensor 17.

For example, in a case where the door opening detection switch 15 detects a state in which any of the doors of the vehicle is open, the actuation by the door lock controller 29 is inhibited irrespective of the detection state based on the door lock sensor 17. Besides, in a case where the door opening detection switches 15 detect a state in which all the doors of the vehicle are closed and where the door lock sensor 17 detects the locked state of the door, the door is unlocked. In a case where the door lock sensor 17 detects the unlocked state of the door, the door is locked.

Subsequently, in addition to the information of the present location of the vehicle and the information of the channel (unusable channel) as have been recorded in the RAM, the information of the channel (usable channel) having succeeded in the certification of the ID is recorded in the channel information record unit 33 (S300). Data similar to the learning data recorded in the channel information record unit 33 are transmitted to the data station 25 through the communication unit 13 (S310). Then, the smart entry control process is ended.

In the data station 25 having received the learning data, the channel information items transmitted from the smart security controller 5 are data-based, together with channel information items transmitted from the smart security controllers of other vehicles.

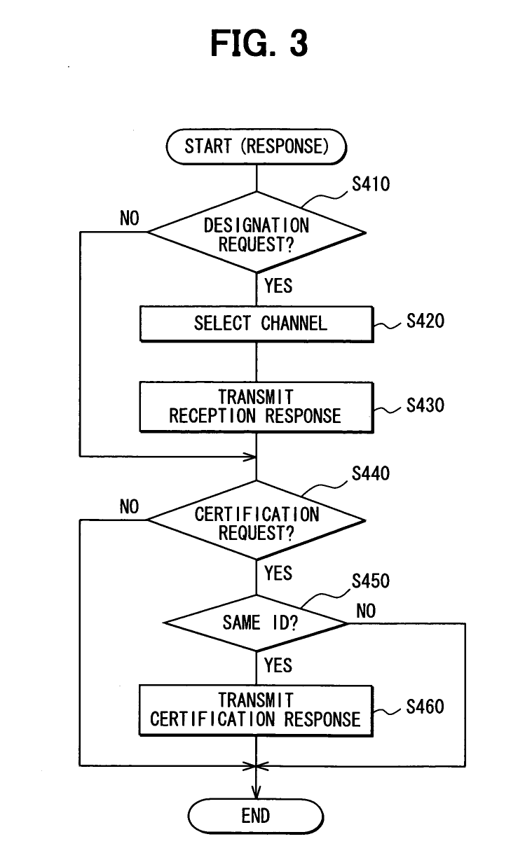

While the smart entry control process is being executed, a response process shown in FIG. 3 is executed by the microcomputer 37 in the portable terminal 3. The response process is activated, for example, when any signal has been received.

The microcomputer 37 first checks whether or not a designation request signal has been received (S410). Unless the designation request signal has been received (S410: NO), the response process directly shifts to S440.

If the designation request signal has been received (S410: YES), a response frequency is set at a channel to select a channel designated by the designation request signal (S420), and a reception response signal is transmitted through the selected channel (S430). Subsequently, the microcomputer 37 checks whether or not a certification request signal has been received (S440).

Unless the certification request signal has been received (S440: NO), the response process is immediately ended. If the certification request signal has been received (S440: YES), the microcomputer 37 checks whether or not the ID of the controller as is contained in the certification request signal agrees with, that is, the same as an ID which the portable terminal 3 has (S450).

Unless the IDs agree (S450: NO), the response process is immediately ended. If the IDs are the same (S450: YES), a certification response signal is transmitted through the same channel as the channel used for the transmission of the reception response signal (S460), whereupon the response process is ended.

Here, the details of the several signals (designation request signal, reception response signal, certification request signal, and certification response signal) will be described with reference to FIG. 4. This figure is a timing chart for explaining the exchanges of the signals between the portable terminal 3 and the smart security controller 5.

First, the designation request signal which is transmitted at S180 of the smart entry control process is formed containing WAKE bits (for example, 4 bit data) which start the portable terminal 3, a designation frequency information signal (for example, 4 bit data) which designates the frequency of the response signal (for example, the channel RF1 is designated), and STOP bits (for example, 2-bit data) which indicate the end of data. When the designation request signal is accurately detected by the portable terminal 3, the reception response signal is transmitted from the portable terminal 3 (S430).

The reception response signal is a signal (for example, 4 bit data) of predetermined pattern merely for replying the reception of the designation request signal at the designated response frequency. In a case where the reception response signal has failed to be normally received by the smart security controller 5 under the influence of jamming noise, the response frequency is altered, and a designation frequency information signal designated (to, for example, the channel RF2) is resent. Then, the portable terminal 3 transmits the reception response signal through the channel (at the response frequency) designated anew.

When the reception response signal is detected by the smart security controller 5 (S190: YES), the certification request signal is transmitted from the smart security controller 5 (S230).

The certification request signal is formed containing START bits (for example, 6-bit data) which indicate a data header, certification data (for example, 60-bit data) which contains the data of an ID, and STOP bits (for example, 2-bit data) which indicate the end of the data. When the portable terminal 3 has detected the designation request signal and has confirmed the agreement between the IDs, the certification response signal is transmitted from the portable terminal 3 (S460).

Likewise to the certification request signal, the certification response signal is formed containing header data HDR (for example, 6-bit data) which indicates a data header, certification data (for example, 69-bit data) which contains the data of the ID, and STOP bits (for example, 2-bit data) which indicate the end of the data.

The electronic key system 1 described above is so configured that the smart security controller 5 and the portable terminal 3 execute the certification by radio communications. In the electronic key system 1, the smart security controller 5 transmits the designation request signal, for which the response frequency is designated, to the portable terminal 3 in the smart entry control process.

When the smart security controller 5 has received from the portable terminal 3 the reception response signal representing to the effect that the designation request signal has been received, it transmits the certification request signal requesting the certification response signal to the portable terminal 3. Further, when the smart security controller 5 has received the certification response signal by the radio communication, it checks whether or not the received ID and the ID of its own agree.

In the response process, the portable terminal 3 selects the response frequency designated by the designation request signal and transmits the reception response signal to the smart security controller 5 at the selected response frequency. Besides, when the portable terminal 3 has received the certification request signal, it transmits the certification response signal containing the ID, to the smart security controller 5.

In a case where the smart security controller 5 cannot receive any signal by the radio communication within a preset allowable time period after the transmission of the designation request signal, it transmits a designation request signal whose response frequency (channel) has been altered to a different frequency.

Accordingly, the frequency (response frequency) of the response signal to be transmitted from the portable terminal 3 can be altered in the absence of a response to the designation request signal. Hence, the response signal can be prevented from failing to be received on account of the radio interference of the response signal. Consequently, the certification can be executed favorably.

Since the transmission and reception of the certification response signal containing the data of the ID are performed after the settlement of the response frequency, a data quantity which is transmitted and received before the settlement of the response frequency can be made small in correspondence with the data of the ID. Therefore, a time period till the settlement of the response frequency can be shortened.

Besides, in the electronic key system 1, the smart security controller 5 transmits the ID possessed by this smart security controller 5, in the state where it is contained in the certification request signal. In addition, the portable terminal 3 checks whether or not the ID of its own and the ID contained in the received certification request signal agree. Subject to the determination that the IDs agree, the portable terminal 3 transmits the certification response signal to the smart security controller 5.

Accordingly, in a case where a plurality of portable terminals 3 exist within the receivable area of the certification request signal, only the portable terminal 3 whose ID agrees with the received ID transmits the certification response signal. It is therefore possible to prevent radio interference which is ascribable to the transmission of the certification response signal by the portable terminal 3 which is irrelevant to the smart security controller 5 of different ID.

Further, the smart security controller 5 is mounted in the vehicle.

Accordingly, the frequency of jamming noise changes depending upon the present location of the vehicle (smart security controller 5). It is therefore possible to enjoy more advantages based on the fact that the response frequency is alterable.

Besides, the smart security controller 5 specifies a usable frequency by referring to the GPS receiver 11 which detects the present location of the vehicle, and channel information (frequency data) in which a frequency usable or unusable as the response frequency and the present location of the vehicle are associated and recorded beforehand in accordance with detection results based on the GPS receiver 11. In addition, the smart security controller 5 transmits to the portable terminal 3, the designation request signal in which the specified usable frequency is designated as the response frequency.

Accordingly, the usable frequency can be set as the response frequency at the beginning by utilizing the channel information, so that a probability at which a certification becomes successful at the first time can be enhanced. Consequently, a time period required for the certification can be shortened.

Further, in a case where the IDs have been determined to agree, the smart security controller 5 records the information of a response frequency designated immediately before, as channel information into the channel information record unit 33 and the data station 25, as a detection result based on the GPS receiver 11.

In accordance with such an electronic key system 1, a database in which the channel information items are accumulated can be built.

Besides, the smart security controller 5 includes the communication unit 13 which communicates with the exterior of this smart security controller 5, and the data station 25 in which the channel information items are recorded is configured so as to be communicable with the smart security controller 5 through the communication unit 13.

Accordingly, the channel information can be shared among a plurality of smart security controllers 5 in such a way that another controller acquires the channel information from the data station 25. Therefore, a certification can be performed more efficiently.

Besides, in a case where the IDs have been determined to agree, the smart security controller 5 actuates the door lock controller 29 previously set.

Accordingly, the door lock controller 29 can be actuated in the case where the IDs have been determined to agree (that is, in the case where the certification has become successful). Therefore, when locking and unlocking are performed in accordance with the result of the certification by way of example, it is possible to build a system in which only authorized users carrying portable terminals 3 are reliably given admission.

The foregoing embodiment may be modified in many ways.

By way of example, the smart security controller 5 may well communicate with the data station 25 and acquire the channel information at any desired time points without being limited to the case of the smart entry control process.

Besides, when the portable terminal 3 has received a designation request signal, it may well transmit a certification response signal without transmitting a reception response signal.

Further, in transmitting a designation request signal whose response signal (channel) has been altered, the smart security controller 5 may well alter a transmission frequency for transmitting each request signal, to a transmission frequency different from the transmission frequency at which the last designation request signal has been transmitted, within a range of frequencies receivable by the portable terminal 3. In this case, the response frequency is altered, and the transmission frequency for transmitting the designation request signal is also altered, so that radio interference can be avoided more reliably. Consequently, a certification can be performed more reliably.

1. A certification system comprising:
a certification medium carried by a user; and
a controller which performs a certification of the medium by radio communications,
wherein the controller includes:
designation request transmission means for transmitting a designation request signal to the certification medium when a manipulation unit of the controller is manipulated, the designation request signal designating a response frequency;
frequency alteration means for causing the designation request transmission means to transmit a designation request signal again by altering the response frequency to a different frequency, in a case where no signal responsive to the designation request signal is received from the certification medium within a preset allowable time period after the transmission of the designation request signal by the designation request transmission means; and
control determination means for checking whether an identifier contained in a certification response signal and an identifier possessed by the controller agree, when the certification response signal containing the identifier for specifying the certification medium is received from the certification medium, and
wherein the certification medium includes:
frequency selection means for selecting a response frequency designated by the designation request signal from among a plurality of frequencies, when the designation request signal is received; and
certification response transmission means for transmitting the certification response signal containing the identifier for specifying the certification medium to the controller at the selected response frequency, after the selection of the response frequency by the frequency selection means.

2. The certification system as in claim 1, wherein:
the controller further includes certification request transmission means for transmitting a certification request signal requesting the certification response signal to the certification medium, when the controller has received from the certification medium a reception response signal representing that the designation request signal is received;
the certification medium further includes reception response transmission means for transmitting the reception response signal to the controller, when the response frequency is selected by the frequency selection means; and
the certification response transmission means transmits the certification response signal to the controller, when the certification request signal is received.

3. The certification system as in claim 2, wherein:
the certification request transmission means of the controller transmits the identifier possessed by the controller in a state where the identifier is contained in the certification request signal;
the certification medium further includes certification checking means for checking whether the identifier contained in the certification request signal and the identifier possessed by the certification medium agree; and
the certification response transmission means transmits the certification response signal to the controller, in a case where the identifier received by the certification checking means and the identifier possessed by the certification medium agree.

4. The certification system as in claim 1, wherein the controller is mounted in a movable object.

5. The certification system as in claim 4, wherein:
the controller further includes
present location detection means for detecting a present location of the moving object; and
frequency specification means for specifying a usable frequency by referring to frequency data in which frequencies usable or unusable as the response frequency and present locations of the moving object are associated and recorded beforehand in accordance with detection results based on the present location detection means; and
the designation request transmission means transmits to the certification medium the designation request signal in which the usable frequency specified by the frequency specification means is designated as the response frequency.

6. The certification system as in claim 5, wherein the controller further includes:
data storage means for storing information of the response frequency, which is designated by the designation request transmission means immediately before, in data record means as the frequency data together with a detection result based on the present location detection means, in a case where the identifiers are determined to agree by the control determination means.

7. The certification system as in claim 6, wherein:
the controller further includes communication means for performing radio communications with exterior of the controller; and
the data record means is disposed in a data station which is communicable with the controller through at least the communication means.

8. The certification system as in claim 1, wherein:
the frequency alteration means causes the designation request transmission means to transmit the designation request signal at a transmission frequency different from a transmission frequency at which a last designation request signal is transmitted.

9. The certification system as in claim 1, further comprising:
actuation control means for actuating a preset object to be controlled, in a case where the identifiers have been determined to agree by the control determination means.

10. A certification method for certifying a portable medium carried by a user of a vehicle by radio communications of an in-vehicle controller with the portable medium, the certification method comprising:
detecting a present location of the vehicle;
selecting one of a plurality of communication channels corresponding to a detected present location by using channel information stored in a channel memory and defining a relation between locations and communication channels indicative of communication frequencies;
transmitting, from the in-vehicle controller, a reception request signal designating a selected communication channel through which a reception response signal is to be transmitted from the portable medium;
repeating transmission of the reception request signal until the reception response signal is received from the portable medium through the selected channel, by changing the selected communication channel if no reception response signal is received from the portable medium;
transmitting, from the in-vehicle controller, a certification request signal after the reception response signal is received;
checking whether an ID included in a certification response signal agrees with an ID stored in the in-vehicle device, when the certification response signal is received from the portable medium;
controlling a predetermined vehicle device automatically based on a check result of the Ids; and
updating the channel information of the channel memory based on the check result of the IDS.
